(19) United States
(12) Patent Application Publication
(10) Pub. No.: US 2006/0227968 A1
(43) Pub. Date: Oct. 12, 2006

(54) Speech watermark system

(76) Inventors: Oscal T.-C. Chen, Min-Hsiung Township (TW); Chia-Hsiung Liu, Liuojiao Township (TW)

Correspondence Address: LIN & ASSOCIATES INTELLECTUAL PROPERTY, P.O. BOX 2339, SARATOGA, CA, 95070-0339, US

(21) Appl. No.: 11/101,921

(22) Filed: Apr. 8, 2005

(51) Int. Cl. H04N 7/167

(52) U.S. Cl. 380/205

(57) ABSTRACT

A time-dependent watermark system is provided for information integrity identification and tampering detection and damaged area reconstruction for digitally recorded speech that can be used as evidence in the court of law. The present invention utilizes the speech characteristics of frame, reconstruction information and time-dependent information to generate watermark for adding to the speech data at the secondary parameters where the impact on the speech quality is minimal. The present invention also provides a detection mechanism of tampering location and tamper way. The analysis scheme, according to the location and the type of the damaged watermark, determines the location and the way of tampering so that the reconstruction can be performed with the reconstruction information established in advance.

### FIELD OF THE INVENTION

The present invention generally relates to a watermark mechanism, and more specifically to a speech watermark applicable to speech data.

### BACKGROUND OF THE INVENTION

The arrival of the digital era, although brought certain convenience to daily life, also brought a few new problematic situations. One of them is the use of digital data as evidence in the court of law. Before the digital recording devices become popular, the authenticity of an original speech tape can be easily determined, and tampered tapes can be identified. However, with the progress of the digital recording technology and ever-decreasing price of related products, more and more people use the digital recording equipments to store and backup the speech data.

The advantage of ease of copy and modification for the digital data also makes the speech data easily tampered. Therefore, when the speech data recorded by digital recording technology used in the court of law, it sometimes faces the difficulty to prove that the data is authentic and can serve as evidence.

The current research on digital watermark mostly focuses on how to embed the watermark in the image data. The major technologies include the use of least significant bit (LSB), signal transformation and spread spectrum. Among them, the signal transformation and spread spectrum techniques are the most used.

The signal transformation technology does not add the watermark in the original signals; instead, it uses a transform technology, such as, Fourier transform, Discrete Cosine Transform (DCT), wavelet transform and Independent Component Analysis (ICA), to transform the original image data into special signals and then alters a part of the data to store watermark.

The spread spectrum technology, on the other hand, multiplies the original or transformed data with a pseudo noise to generate a watermark for embedding to the signal. It requires the decoder to know the format of the pseudo noise for decoding the watermark.

Based on the applications, the digital watermarks can be categorized as a robust watermark suitable for copyright protection and a fragile watermark suitable for ensuring the data correctness. The robust watermarks cannot be removed even when the data is compressed, edited, resized, filtered, re-quantized, and other attacks. The robust watermarks mostly use signal transformation and spread spectrum technologies. On the other hand, the fragile watermarks will disappear when the data is attacked or changed. The LSB technology is the representative of this type of watermarks.

In the audio watermark technologies, in addition to the signal transformation and spread spectrum, W. Bender proposed a method to utilize the time domain masking effect in human hearing perception and add echoes at various lengths to the original audio data as the audio watermark.

Chung-Ping Wu and C-C Jay Kuo proposed, in both “Fragile speech watermarking based on exponential scale quantization for tamper detection,” 2002 IEEE International Conference on Acoustics, Speech, and Signal Processing, vol. 4, pp. 3305-3308, 2002, and “Fragile speech watermarking for content integrity verification,” 2002 IEEE International Symposium on Circuits and Systems, vol. 2, pp. 436-439, a method based on a simplified masking effect of human hearing to modify the exponential-scale quantization value or add a fragile watermark less than the masking threshold in the speech data to distinguish malicious tampering from normal modification. Based on their research, the watermark added by modifying the exponential-scale quantization value will disappear due to the code excited linear prediction (CELP) compression, and, therefore, cannot guarantee the integrity of CELP compressed speech data. It can only be used to protect un-quantized or adaptive differential pulse code modulation (ADPCM) compressed data. The watermark added in accordance with the human hearing's masking threshold, although can be used in CELP compression mechanism, sometimes fails to detect the malicious tampering.

Although the structure proposed by Wu can distinguish malicious tampering from normal modification, there is still grey area between the malicious and normal modification as defined by the court of the law. To overcome this shortcoming, as long as the watermark is detected to indicate the modification of data, either malicious or normal, the modified data cannot serve as evidence in the court of law. On the other hand, the proposed structure adds the watermark to the original waveform and uses the human hearing's masking effect model. The mechanism of adding watermarks tends to complicate the structure.

The most commonly used method for utilizing watermark is to use a frame (a segment) of the most representative image for the owner as the copyright image (copyright data), and use the watermark algorithm to hide the copyright image (copyright data) into the protected image (data). When the same copyright image (copyright data) can be extracted from other images (data) using the watermark algorithm, it indicates that the image (data) is either illegally used or intact.

However, the method of adding watermark with a fixed content is not applicable to ensuring the integrity of the speech signals. Because the speech signal is a one-dimensional signal, it can be easily modified by insertion, deletion or substitution of key phrases without changing the individual speech frame. Therefore, the added watermark must be able to change with the time and the content, in addition to disappearing when the speech content is modified.

P. S. L. M. Barreto, H. Y. Kim, and V. Rijmen proposed, in “Toward secure public-key blockwise fragile authentication watermarking,” IEE Proceedings Vision, Image and Signal Processing, pp. 57-62, Vol. 149, April 2002, a method for using the width, height and the block information of the image to generate an automatic watermark that can change with the time or the content. Taiwan Patent No. 00,451,590 disclosed a digital image surveillance system based on digital watermark for preventing modification, in which Wu used time information and image content to generate image watermark.

However, the aforementioned methods use the LSB of the original image to store the watermark. The watermark stored in the LSB can be damaged due to the compression of the image, and is unable to prevent the compressed data from modification.

Furthermore, the current majority of speech compression technologies use hybrid encoding, which has a bit rate from 2.4 to 16 Kbps. They utilize the characteristics of the speech or the uttering process to establish various models to approximate voice. The encoding process is to find the most suitable parameters of the used model. Because it is impossible to generate high quality speech solely on the established model, such as all pole model or harmonic pulse noise model (HNM) at present, the residual signals which are unable to be approximated by models are compressed by using the waveform encoding. Therefore, the parameters generated by this type of encoding technologies are divided into two categories. First, the important parameters are required by all models to synthesize speech, such as line spectral pair (LSP), speech pitch and energy. The characteristic is that, once the parameters are changed, the content or the perceptual features of the decoded speech will also be changed. The second category of the parameters is used for improving speech quality, such as the locations of excitation pulses, which make the speech sound natural. The change of this category of parameters will only slightly degrade the speech quality, instead of changing the speech content after decoding. Because hybrid encoding technologies have the advantages of high speech quality and low bit rate, they are adopted by most digital recording devices. Some of the most representative examples include G.723.1 and G.728 standards proposed by ITU and mixed excitation linear prediction (MELP) proposed by NIST.

The compression process of G.723.1 is to divide the speech signals into multiple 240 point speech frames, with each speech frame having four 60-point sub-frames. During compression, G.723.1 extracts 10 LPC parameters, transforms them into LSP, performs split vector quantization to quantize the LSP, and performs pitch searching and gain quantization. Finally, the excitation signal is compressed by different quantization ways according to different bit rate required. For example, when the bit rate is 6.3 kbps, the numbers of the excitation signals in the even sub-frames and the odd sub-frames are five and six, respectively. When the bit rate is 5.3 kbps, the numbers of excitation signals in the even and odd sub-frames are four, and the locations of the excitation signals are more regular than those at 6.3 kbps.

### SUMMARY OF THE INVENTION

The present invention has been made to overcome the above-mentioned drawbacks of conventional watermark methods. The primary object of the present invention is to provide a speech watermark system applicable to adding watermarks to the speech data during the compression, while reducing the system complexity.

Another object of the present invention is to provide a speech watermark system, which can be used to determine the integrity of speech data by analyzing the correctness of the speech watermark added to the speech data.

Yet another object of the present invention is to provide a speech watermark system, which can re-construct the damaged speech data by the pre-stored reconstruction information.

To meet the aforementioned objects, the watermark system of the present invention includes a watermark generation and addition device, a watermark extraction and identification device, a tampering identification device and a damaged-area reconstruction device.

The aforementioned watermark generation and addition device is, based on a watermark generation mechanism, to add speech watermarks and reconstruction information to the compressed speech data. The speech watermark is constructed based on the time information and the speech content. The watermark extraction and identification device is, based on the watermark generation mechanism, to extract the speech watermarks from the speech data which watermarks have been added to. Also, based on the speech data which watermarks have been added to, the identification watermark similar to the speech watermark can be obtained. By comparing the identification watermark and the extracted speech watermark, the result can be determined. The tampering identification device, based on estimating the time information of the corresponding speech watermark in the damaged speech frame, obtain the tampered location and the tampering way used to tamper the speech data. The damaged-area reconstruction device, based on the type and the location of tampering, determines the reconstructive area of the speech data and extract the corresponding reconstruction information from the speech data to reconstruct the area.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a watermark system of the present invention;

FIG. 2 shows a schematic view of a watermark generation and addition device of the present invention;

FIG. 3 shows a schematic view of the choice of time information according to the present invention;

FIG. 4 shows a schematic view of a flowchart of the watermark generation according to the present invention;

FIG. 5 shows a schematic view of a watermark extraction and identification device of the present invention;

FIG. 6 shows a schematic view of a tampering identification device of the present invention;

FIG. 7 shows a schematic view of determining the tampering of data;

FIG. 8 shows a schematic view of a damaged area reconstruction device of the present invention; and

FIGS. 9A-9D show the experiments and the results of the present invention.

### DETAILED DESCRIPTION OF THE PREFERRED EMBODIMENTS

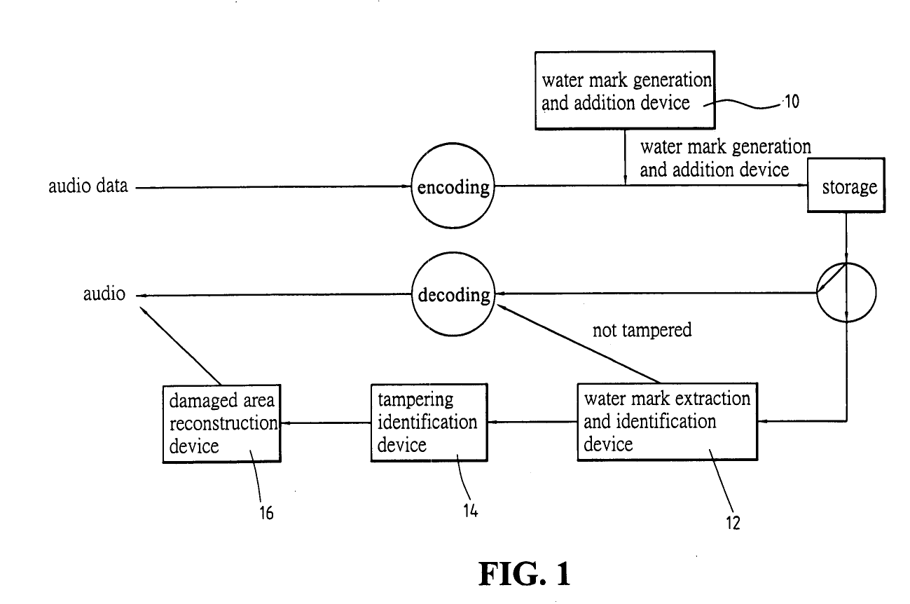

FIG. 1 shows a schematic view of a watermark system of the present invention. As shown in FIG. 1, the watermark system of the present invention includes a watermark generation and addition device 10, a watermark extraction and identification device 12, a tampering identification device 14, and a damaged-area reconstruction device 16.

To reduce the complexity of the speech watermark system, watermark generation and addition device 10, based on the watermark generation mechanism, will add the speech watermark and the reconstruction information for reconstructing speech data to the speech data during its compression. The compressed and watermarked speech data are then stored in the storage device. It is worth noticing that the compressed speech data, while added with watermarks, can still be decoded by the original decoding mechanism in a player without identifiable degradation on human hearing.

When it is necessary to identify the existence of tampering, watermark extraction and identification device 12 of FIG. 1 can be used to perform the identification. Watermark extraction and identification device 12, based on the watermark generation mechanism used by watermark generation and addition device 10, obtains an identification watermark from the speech data. This identification watermark has the characteristics similar to those of the watermark originally added to the speech data. This identification watermark is then compared to the speech watermark extracted from the speech data. If both are identical, the speech data is intact; otherwise, the speech data has been tampered. Watermark extraction and identification device 12 can determine the result by the comparison of the identification watermark and the extracted watermark.

Because the speech data includes a plurality of speech frames, watermark extraction and identification device 12 must generate an identification watermark for each speech frame for comparison. When all the speech frames are compared, the system will perform a preliminary analysis of the comparison results. If most of the watermarks in the frames are damaged, it indicates that the speech data has been maliciously tampered and is not suitable to use as evidence in the court of law. On the other hand, if only a certain number of watermarks in the frames are damaged, the system will collect the comparison results and send them to tampering identification device 14 for the identification of location and the way used for tampering.

Tampering identification device 14 estimates the time information of the watermarks corresponding to the frames before and after the regions where the watermark are damaged. By observing the changes and the continuity of the aforementioned time information, tampering identification device 14 determines the locations where the speech data are tampered and the way used to tamper the speech data. Finally, the tampered frames and the reason of damage are listed and sent to damaged-area reconstruction device 16 for reconstructing the tampered speech data.

To avoid a large amount of data required for embedding, the reconstruction information must be well selected. This implies that some of the damaged areas are unable for reconstruction. Damaged-area reconstruction device 16, before starting the reconstruction, must determine the reconstruct-able regions according to the location and the way of the tampering, and then reconstruct the regions based on the corresponding information extracted from the speech data.

In the following, the details of watermark generation and addition device 10, watermark extraction and identification device 12, tampering identification device 14 and damaged-area reconstruction device 16 of the speech watermark system of the present invention will be described.

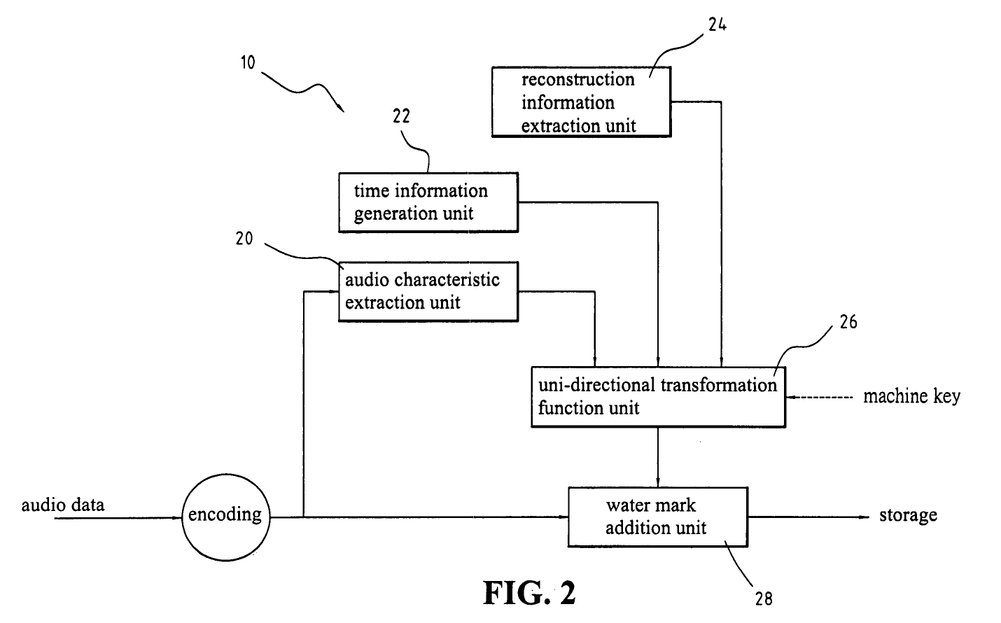

FIG. 2 shows a schematic view of the watermark generation and addition device of the present invention. As shown in FIG. 2, watermark generation and addition device 10 includes a time information generation unit 22, a speech characteristic extraction unit 20, a uni-directional transformation function unit 26, a watermark addition unit 28, and an optional reconstruction information extraction unit 24. Reconstruction information extraction unit 24 is optional because the reconstruction information is only required for reconstructing damaged regions and not for tampering identification. However, for the purpose of explanation, reconstruction information extraction unit 24 is included in the description. In addition, the speech data include a plurality of speech frames, and a fixed number of frames are defined as a group. The last group of speech data may have less number of frames than the other groups.

The watermark W generated by watermark generation and addition device 10 can be expressed by the following equation:
W=Hx(T, R, F) (1)
where Hx is the uni-directional function specific to a digital recording device (uni-directional transform function unit 26), T is the time information (time information generation unit 22), R is the reconstruction information (reconstruction information extraction unit 24, and F is the speech characteristic value (speech characteristic extraction unit 20).

Time information T can be expressed in absolute time like yyyy/mm/dd/hh/mm/ss, relative time like the recording time, or relative location information like the number of frames, the index G corresponding to the group, and a generated watermark W_{old} (usually the previous one). Reconstruction information R is obtained by using the location transformation (not shown) or first-in-first-out (FIFO) register to compute the location of a specific frame and then extracting the required information from that located frame. Speech characteristic value F consists of all or part of the Line Spectral Pair (LSP) parameters of the frame and a speech pitch. It is worth noticing that both the location transformation and FIFO register are only for accessing required data during the reconstruction. The FIFO only provides linear delay, while location transformation provides more powerful location transformation. The following provides the details of how to determine the time information T, reconstruction information R, and speech characteristic value F.

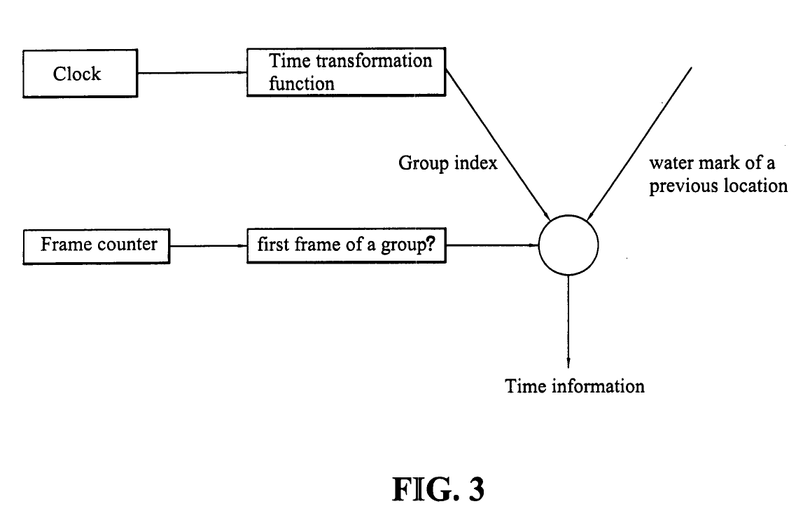

FIG. 3 shows a schematic view of the choice of time information. As shown in FIG. 2, time information generation unit 22, based on the location, time or sequence between the frames, generates time information T. That is, as shown in FIG. 3, time information T can be either watermark W_{old} of the previous corresponding frame, or the index G specific to each group.

When the number of frames in a group is not fixed, the starting or ending location of each group can be determined by all kinds of situations during the recording, such as silence, or system generated specific watermark. In the following, a scenario of using group index G or the generated watermark W_{old} as time information T is described. It is worth noticing that this is only used as an embodiment, and the present invention is not limited to this embodiment.

Combining the two time information generation mechanisms, the watermark generation mechanism of the present invention can be expressed as equations (2a) and (2b). The system can switch between the two different time information generation mechanisms according to the relative position of the individual frame within a group or waiting for the specific conditions, such as silence.
W_{old}=Hx(G, R, F) (2a)
W_{new}=Hx(W_{old}, R, F) (2b)
As shown in FIG. 3, when the currently processed frame is the first frame within a group, time information generation unit 22 will automatically choose group index G as time information T, while watermark generation and addition device 10 chooses (2a) to generate watermark W_{old}. On the other hand, if the frame is not the first frame within a group, watermark W_{old} is used, while watermark generation and addition device 10 uses (2b) to generate watermark W_{new}.

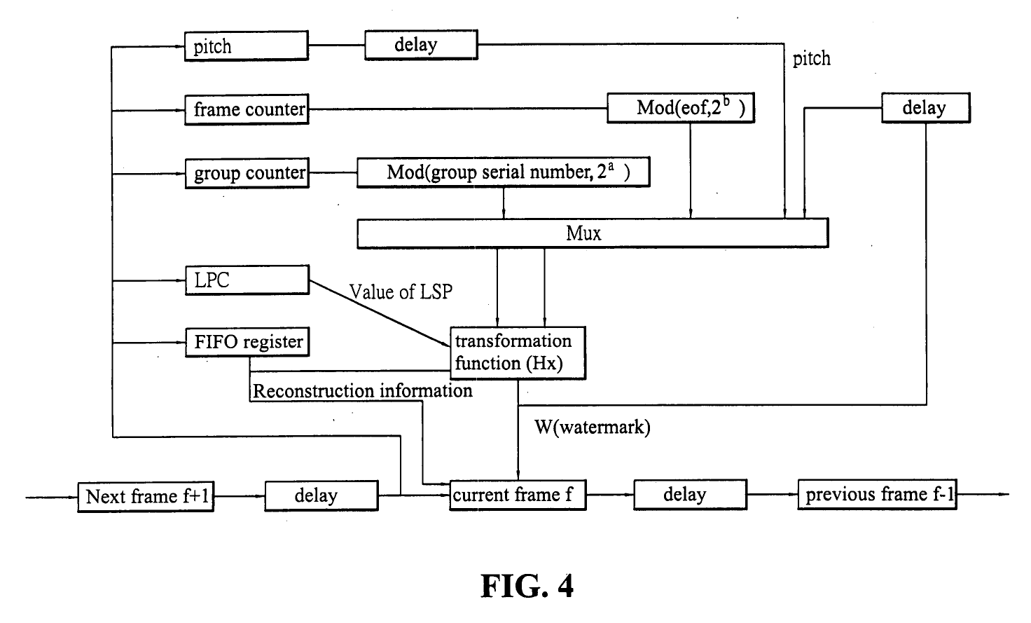

FIG. 4 shows a schematic view of a flowchart of the watermark generation according to the present invention. As shown in FIG. 4, time information generation unit 22, based on a group counter, generates group index G by transforming the frame time or the group location sequence number with a time transformation function, such as Mod(group location sequence number, 2^{a}); that is, the remainder of the location sequence number divided by 2^{a}, where a is the number of bits of the watermark stored in a frame. In this embodiment, a equals to four.

Speech characteristic value F is generated by speech characteristic extraction unit 20 of FIG. 2 according to the LSP, pitch and energy of the speech data that can interpret speech characteristics. That is, in each frame, extract 8 bits of LSP, L=[L₁, L₂, . . . , L₈] from the quantized LSP, then extract 2 bits of pitch P=[P₁,P₂], and combine the L and P to form speech characteristic value F required by the watermark. For the final frame, as it is impossible to extract pitch information from the next frame, the remainder of the number of frames in the group (eof) divided by 2^{b} is used, as shown in FIG. 4 by Mod (eof, 2^{b}), where b is the number of bits of the pitch, which is 2 in this embodiment. According to Mod (eof, 2^{b}) and the characteristic value L extracted -from LSP, a complete speech characteristic value F is obtained.

Reconstruction information extraction unit 24 of FIG. 2, based on re-estimating parameter model, re-quantization and interpolation, obtains the reconstruction information required for reconstructing the frame, stores the reconstruction information to the FIFO register shown in FIG. 4, and takes the reconstruction information for a specific frame from the register to generate a watermark. In other words, by re-estimating parameter model, re-quantization and interpolation, 8 bits are selected to represent the LSP, pitch and energy information of the speech. To reduce the size of the stored reconstruction information, only the reconstruction information of odd frames is stored in the corresponding odd and even frames, while the reconstruction information for even frames is not stored. Therefore, during the reconstruction, the odd frames can be reconstructed directly, but the even frames must be obtained by interpolation of odd frames.

For example, if there are 100 frames in each group except the last one of speech data, which has eof frames, in order to reduce the system complexity, reconstruction information R of odd frames will be stored in a FIFO register capable of delaying for 1000 frames. Hence, the information R_{100g+f} and R_{100g+f+1} used for reconstructing the f-th frame of the g-th group are stored in the FIFO register for the delay of 1000 frames, and then information R_{100g+f-1000} for the frame at 1000 frames earlier than the current frame is taken from the register. On the other hand, if the f-th frame of the g-th group is an even frame, only information R_{100g+f-1000} is taken from the register. When the FIFO is replaced by a location transformation unit, no delay is required to be taken into account. Regardless of the register type, when the odd frames are processed, the reconstruction information is first computed, divided into two halves to store in FIFO, and then one is taken out from FIFO. When the even frames are processed, only reconstruction information is taken out, and no further analysis is required.

In summary, when the frame is neither the first of a group nor the last of the speech data, time information T of the frame is watermark W_{old} generated by the previous neighboring frame, and the speech characteristic value F of the frame is the combination of a part of LSP of the frame and a part of pitch of the next frame. The watermark generation mechanism is interpreted by equation (3a). On the other hand, when the frame is the first of a group, time information T is the group index, and the watermark generation mechanism is interpreted by equation (3b). Finally, when the frame is the last of the speech data, the speech characteristic value consists of a part of LSP and the remainder of the number of frames (eof) divided by 4 (2^{b}), and the watermark generation mechanism is interpreted by equation (3c).

W_{g,f}=Hₓ(W_{g,f-1}, R_{100g+f-1000}, G_{g,f}, P_{g,f+1}) (3a)

W_{g,1}=Hₓ(G_{g}, R_{100g+f-1000}, L_{g,1}, P_{g,2}) (3b)

W_{g,eof}=Hₓ(W_{g,eof-1}, R_{100g+eof-1000}, L_{g,eof}, Mod(eof, 2²)) (3c)

Up to this point, time information T, reconstruction information R, and speech characteristic value F required for generating watermark W are all computed. Therefore, unidirectional transformation function unit 26 of FIG. 2 uses a machine key to determine the uni-directional transformation function Hx, and transforms the original datum having the number of bits greater than or equal to the number of bits of watermark into a 4-bit watermark W=[W₁, W₂, W₃, W₄] in accordance with equations (3a)-(3c), where W1 W2, W3 and W4 represent the first, second, third and fourth bits of watermark, respectively. The uni-directional function can be a hashing or other encryption function. The machine key is machine dependent.

According to the previous description of speech encoding, the digital speech recording equipments generate primary parameters and secondary parameters in a hybrid encoding technologies. The primary parameters are those parameters, after decoding, will affect the speech content or other perceptual speech characteristics, i.e., parameters for speech model. The secondary parameters include the rest of parameters which are not primary, such as, those which change the speech quality, but not the content. When the speech data is maliciously tampered, the primary parameters will also be changed. Besides, because the slight change to the secondary parameters will only slightly affect the speech quality, the secondary parameters can be used for storing watermark and reconstruction information.

Therefore, watermark addition unit 28 adds the watermark to speech data by changing the secondary parameters. In other words, if the secondary parameter is an excitation signal, watermark addition unit 28 adds watermark to the speech data by changing the LSB of the second excitation signal in each sub-frame, and adds reconstruction information R to the speech data by changing the LSB of the fourth excitation signal in each sub-frame. The reason behind this choice is that a frame in G.723.1 is further divided into four sub-frames, and each sub-frame has a plurality of excitation signals. Therefore, it is sufficient to store the 4-bit watermarks and the 4-bit reconstruction information.

The aforementioned can be summarized as a watermark generation and addition algorithm, including the steps of:

Step 1: setting parameters. Let each group have 100 frames, and extract 8 bits and 2 bits from the LSP and the pitch, respectively, of each frame as the speech characteristic value required for generating a watermark. Each frame will be added with a 4-bit watermark and 4-bit reconstruction information.

Step 2: using Mod(g, 2⁴) to generate the group index G_{g} of the g-th group.

Step 3: extracting LSP characteristic value L_{g,f} from the f-th frame of the g-th group.

Step 4: extracting pitch characteristic value P_{g,f+1}, from the (f+1)-th frame of the g-th group.

Step 5: if the f-th frame of the g-th group being an odd frame, using re-estimating model, re-quantization and interpolation to obtain the required reconstruction information R_{100g+f} and R_{100g+f+1}, and storing them into an FIFO register which having a delay of 1000 frames, and taking reconstruction information R_{100g+f-1000} from the FIFO register; if the f-th frame of the g-th group being an even frame, taking reconstruction information R_{100g+f-1000} from the FIFO register.

Step 6: using a specific machine key to determine the uni-directional transformation function Hx.

Step 7: based on the relative location of the frame within a group or the entire speech data to determine the mechanism for generating watermark W:

(a) the first frame of the g-th group:
W_{g,1}=Hₓ(G_{g}, R_{100g+1-1000}, L_{g,1}, P_{g,2});

(b) others:
W_{g,f}=Hₓ(W_{g,f-1}, R_{100g+f-1000}, L_{g,f}, P_{g,f+1})

Step 8: storing the generated watermark to the LSB of the second excitation signal of each sub-frame, and reconstruction information R_{100g+f-1000} of the frame 1000 earlier to the LSB of the fourth excitation signal of each sub-frame.

Step 9: reading the data of the next frame, if the next frame being not the last frame, repeating steps from 2 to 9.

Step 10: if the frame being the last frame of the speech data, the watermark W being expressed as:

W_{g,eof}=Hₓ(W_{g,eof-1}, R_{100g+eof-1000}, L_{g,eof}, Mod(eof, 2²));

where eof being the number of frames within this group.

It is worth noticing that not all the first frame of each group must use the group index as the time information. Also, the number of frames in each group can be variable; however, this design will make the system more complicated, as this will require the system to perform the silence detection or determine specific watermarks. For example, in the aforementioned step 1, when each group has a plurality of frames, and the watermark generated by the current frame is the 11^{th} of “1001” in that group, it can have the case of that 19 frames after the current frame is the last frame of the group, and the third frame of each group can use the group index as the time information. In that case, the aforementioned step 7 must be changed to:

(a) the frame being the third frame of the g-th group:
W_{g,3}=Hₓ(G_{g}, R₋₁₀₀₀, L_{g,3}, P_{g,4})

(b) the frame being the first frame of the g-th group:
W_{g,1}=Hₓ(W_{g-1,end}, R₋₁₀₀₀, L_{g,1}, P_{g,2})

(c) others:
W_{g,f}=Hₓ(W_{g,f-1}, R₋₁₀₀₀, L_{g,f}, P_{g,f+1})

Where W_{g-1,end} is the watermark generated by the last frame of group (g−1). When the current group is the first group of the speech data and cannot refer to the watermark generated by the last frame of the previous group, the user can determine the initialization of the watermark.

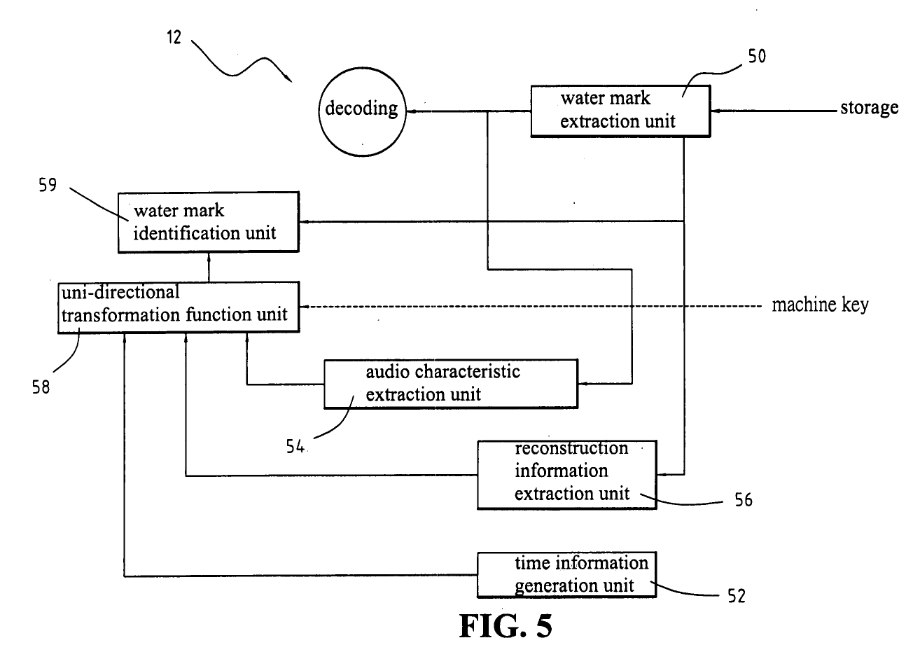

FIG. 5 shows a schematic view of the watermark extraction and identification device of the present invention. As shown in FIG. 5, watermark extraction and identification device 12 and watermark generation and addition device 10 have the same time information generation unit 52, reconstruction information extraction unit 56, speech characteristic extraction unit 54, and uni-directional transformation function unit 58. Other than reconstruction information extraction unit 56 reads the reconstruction information stored in a specific excitation location of the frame, instead of re-computing the reconstruction information, its functional blocks that are identical to those of watermark generation and addition device 10 will operate in the same way. In other words, the identification watermark generated by watermark extraction and identification device 12 will have the same characteristics as the speech watermark added to the speech data. Therefore, the same description will not be repeated here.

Because the same watermark generation mechanism is used, the identification watermark generated by time information generation unit 52, reconstruction information extraction unit 56, speech characteristic extraction unit 54 and uni-directional transformation function unit 58 should be identical to, for watermark identification unit 59, the speech watermark extracted by watermark extraction unit 50 from the speech data stored in the storage device. Therefore, if some of the frames are different, it indicates the speech data may include tampered or damaged frames. This is, by determining the integrity of the watermarks added to the speech data, to identify the integrity of the speech data.

The aforementioned can be summarized as the watermark extraction and identification algorithm, including the steps of:

Step 1: setting parameters. Let each group have 100 frames, and extract 8 bits and 2 bits from the LSP and the pitch, respectively, of each frame as the speech characteristic value required for generating a watermark.

Step 2: using Mod(g, 2⁴) to generate the group index G*_{g} of the g-th group.

Step 3: extracting LSP characteristic value L*_{g,f} from the f-th frame of the g-th group.

Step 4: extracting pitch characteristic value P*_{g,f+1} from the (f+1)-th frame of the g-th group.

Step 5: reading reconstruction information R*_{100g+f-1000} stored at the LSB of the fourth excitation signal location of each sub-frame.

Step 6: using specific machine key to determine uni-directional transformation function H*ₓ.

Step 7: extracting watermark W* stored at the LSB of the second excitation signal location of each sub-frame.

Step 8: determining if the watermark matching the following equations:

(a) the first frame of the g-th group:
W*_{g,1}=H*ₓ(G*_{g}, R*_{100g+1-1000}, L*_{g,1}, P*_{g,2});

(b) others:
W*_{g,f}=H*ₓ(W*_{g,f-1}, R*_{100g+f-1000}, L*_{g,f}, P*_{g,f+1})

Step 9: if the watermark being extracted matching the equations in step 8, the frame being not tampered; otherwise, the watermark being damaged and the speech data in this frame being tampered.

Step 10: reading the data of the next frame, if the next frame being not the last frame of speech data, repeating steps from 2 to 10.

Step 11: if the frame being the last frame of the speech data, determining if the watermark being extracted matching the following equation; if so, the frame not tampered; otherwise, the watermark being damaged and the speech data in this frame being tampered:
W*_{g,eof}*=H*ₓ(W*_{g,eof}*₋₁, R*_{100g+eof}*₋₁₀₀₀, L*_{g,eof}*, Mod(eof*, 2²));
where eof* being the number of frames within this group.

It is worth noticing that not all the first frame of each group must use the group index as the time information. Additionally, the number of frames in each group can be variable; however, this design will make the system more complicated, as this will require the system to perform the silence detection or determine the specific watermark. For example, in the aforementioned step 1, when each group has a plurality of frames and the watermark generated by the current frame is the 11^{th} of “1001” in that group, it can have the case of that 19 frames after the current frame is the last frame of the group, and the third frame of each group must use the group index as the time information. In that case, the aforementioned step 8 must be changed to:

(a) the frame being the third frame of the g-th group:
W*_{g,3}=H*ₓ(G*_{g}, R*₋₁₀₀₀, L*_{g,3}, P*_{g,4});

(b) the frame being the first frame of the g-th group:
W*_{g,1}=H*ₓ(W*_{g-1,end}, R*₋₁₀₀₀, L*_{g,1}, P*_{g,2})

(c) others:
W*_{g,f}=H*ₓ(W*_{g,f-1}, R*₋₁₀₀₀, L*_{g,f}, P*_{g,f+1})

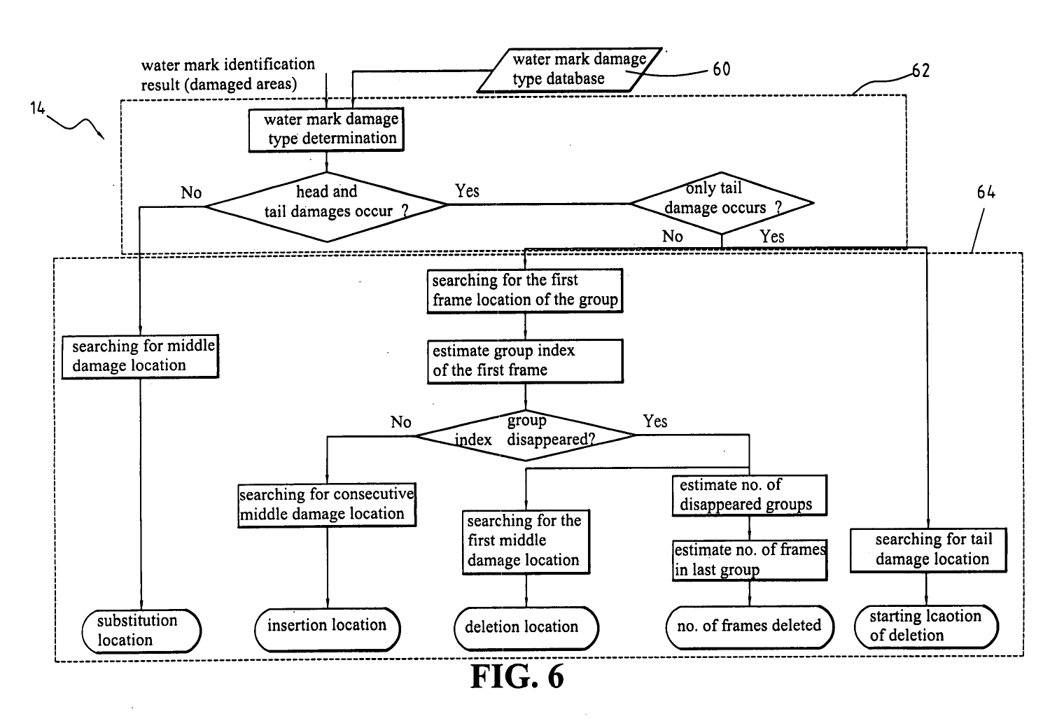

FIG. 6 shows a schematic view of the tampering identification device of the present invention. As shown in FIG. 6, a tampering identification device 14 includes a watermark damage type database 60, a damage identification unit 62, and an identification unit 64. In FIG. 6, the steps in damage identification unit 62 and identification unit 64 are described. Each frame in a group includes a watermark, and only a frame in each group use the group index as the time information to generate the watermark.

Tampering identification device 14 of the present invention is mainly for analyzing the type, the location and the way of tampering speech data. Before the identification, the definition of the tampering types must be stored to watermark error type database 60. The tampering types, based on the time information types used to generate the watermark and the tampering location of the frame within a group, include the head damage, tail damage, and the middle damage.

For example, when the first frame of each group must use the group index as the time information, the head damage indicates that damaged location of the watermark is the first frame of each group, and the watermarks of both neighboring frames are correct. If either neighboring frame includes damaged watermark, this watermark is not identified as a head damage. The tail damage indicates that the damaged location of the watermark is the last frame of the entire speech data, and the watermark of the previous neighboring frame must be correct. The middle damage indicates that the damaged location is other than the head or the tail.

The tampering way can be preliminarily identified based on the following rules: a head damage or a tail damage indicates the tampering way may be insertion or deletion, and a middle damage indicates that the tampering way may be insertion, deletion or substitution.

As shown in FIG. 6, damage identification unit 62, based on tampering type definition, analyzes the discovered damaged areas (provided by watermark extraction and identification device 12) and concludes the tampering types. Identification unit 64 obtains the corresponding group index from each group to analyze, based on the overall rules of the identification type, the content of the group index, and obtains the tampering way and tampering location of the damaged areas of the speech data. In other words, the tampering location of substitution, the tampering location of insertion, the tampering location of deletion and the number of the deleted frames, and the starting location of the deleted frames are all obtained.

As one of the identification rules says that the continuity of group indexes and normal termination of the speech data imply the tampering way may be substitution tampering, and damage identification unit 62 first identifies whether a head or tail damage occurs, as shown in FIG. 6. If so, the indication is that a part of the speech data has been inserted or deleted so that the time information in some frames are incorrect; otherwise, only a part of speech data is being substituted in this speech data. Identification unit 64, as shown in FIG. 6, will find the continuous damaged locations to generate the tampering locations of substitution.

Another identification rule says that the discontinuity of the group indexes and the discontinuity occurring at the points where the separated indexes are neighbored, or continuity in group indexes but abnormal termination of speech data imply that the starting location of the damaged area is the starting point of the deletion tampering. Therefore, when damage identification unit 62 identifies the speech data being inserted or deleted, it will automatically identify whether only a tail damage occurs in the last frame of the entire speech. When damage identification unit 62 finds only one tail damage occurring in the last frame of the entire speech, the indication is that speech data terminate abnormally. The starting point of the deleted frame can be obtained by finding the location of the tail damage.

When the tail damage occurs with head damages, identification unit 64 will find the list of the middle damages having the length of a frame. It also assumes that before being tampered, these damaged frames are all the first frame of their groups, and that the time information damages leading to the watermark damages are caused by the speech data tampered by insertion or deletion. The present invention further assumes the reconstruction information and speech characteristic values are correct, and finds the correct time information by using a full searching scheme. On the other hand, when no middle damages having the length of a frame can be found, the program will perform a full search scheme on the head damage frames to find the time information of the frames.

Identification unit 64, after identifying the time information of the first frame in each group, starts to check the time information of the groups neighboring to the groups having continuous middle damages. In other words, the purpose is to identify whether a group index G disappears.

If the disappearance of time information occurs, for example, the time information sequence is 125, 126, xxx, 130, 131, where xxx is the damaged area, the indication is that some frames have been deleted, and the deletion starts at the location of the first middle damage. The location is the starting point of the deletion tampering.

Yet another identification rule says that the discontinuity of group indexes and the discontinuity occurring at the points where the continuous indexes are separated, the implication is that the damaged location is the location for insertion tampering. So, when the time information sequence such as 125, 126, xxx, 127, 128 occurs, the implication is that data have been inserted at the location having the time information xxx.

Finally, for the convenience of reconstruction, the length of deleted frames is estimated. The estimation scheme includes the estimation of the deleted frame length according to the number of disappearing groups, the use of information on the number of frames stored in the last frame, and the relative location of the middle damage in the group.

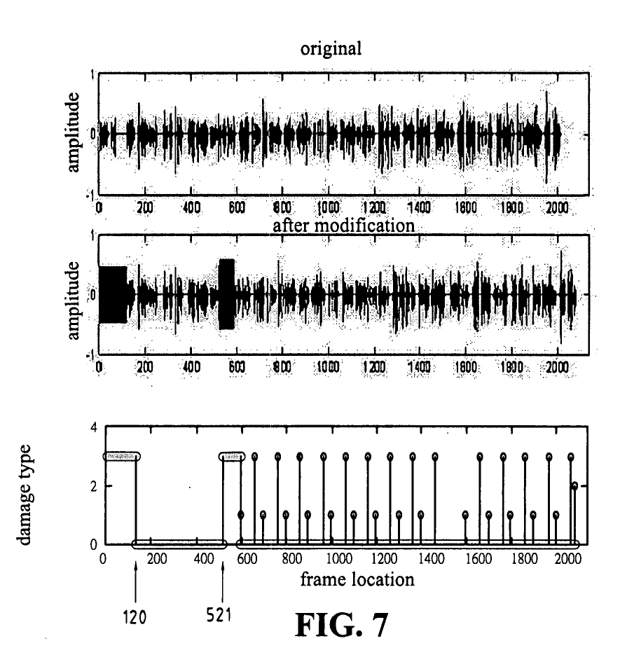

FIG. 7 shows a schematic view of the tampering identification. As shown in FIG. 7, speech data having the length of 2019 frames are added with watermarks. The contents of the frames from 1^{st} to 120^{th} are substituted with noises, and the location of the 521^{st} frame is inserted with noises having the length of 65 frames.

From the damage types vs. frame locations, it is obvious that middle damages (type III) occur at the locations of substitution and insertion. In addition, the head damages (type I) and middle damages occur starting at the 601^{st} frame until the end of file in an interwoven manner. The tail damage (type II) occurs at the last frame of the entire speech, and it is because the first frame of each group will move backwards after the insertion. The movement of the frame will damage the watermark due to the incorrect time information, which is the reason why the 666^{th} and 766^{th} frames, and so on are not tampered but have middle damages. In addition, the 601^{st}, 701^{st} and other frames, although not tampered, will have head damages due to the lack of correct time information. According to the rules, a head damage should occur at the 1051^{st} frame and a middle damage should occur at the 1566^{th} frame. However, these damages do not occur because the combination of the neighboring frames coincidentally matches the watermark identification rules.

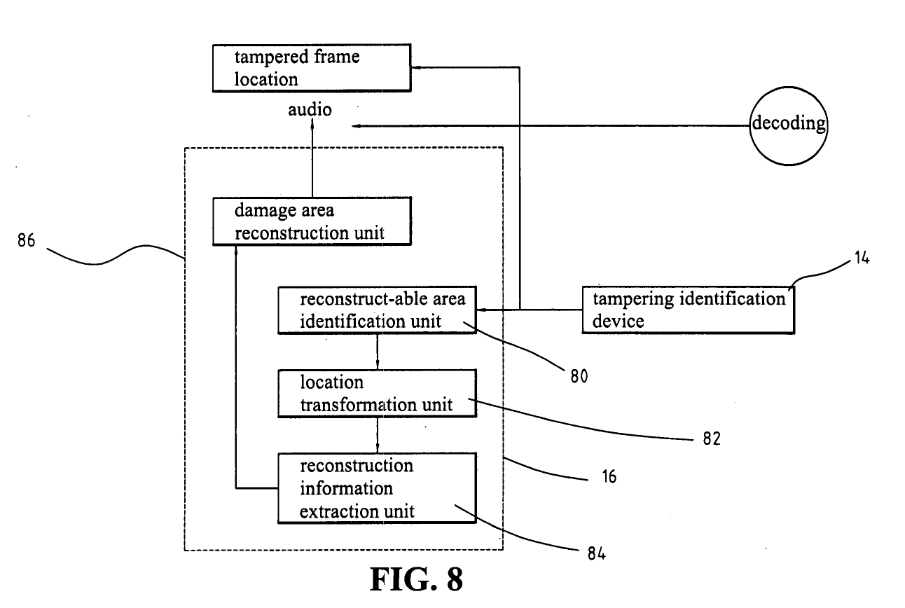

FIG. 8 shows a schematic view of the damaged area reconstruction device of the present invention. As shown in FIG. 8, a damaged area reconstruction device 16 includes a reconstruct-able area identification unit 80, location transformation unit 82 (or an FIFO register), reconstruction information extraction unit 84 and a damaged reconstruction unit 86.

Reconstruct-able identification unit 80 is for determining which damaged areas are reconstruct-able after receiving the tampering type and tampering location provided by tampering identification device 14. It is necessary to determine first which areas are reconstruct-able because some frames storing reconstruction information may be damaged, and their reconstruction information cannot be found in the FIFO register. Therefore, at the beginning of the reconstruction, it is necessary to identify the damaged areas as reconstruct-able when the reconstruction information can be found in FIFO register.

After the reconstruct-able areas are determined, location transformation unit 82 finds the watermarks containing the reconstruction information of the reconstruct-able areas, and reconstruction information extraction unit 84 extracts reconstruction information from the frame. Finally, damaged area reconstruction unit 86, according to the extracted reconstruction information, reconstructs the reconstruct-able areas. Therefore, the present invention can reconstruct the damaged speech data by establishing reconstruction information in advance.

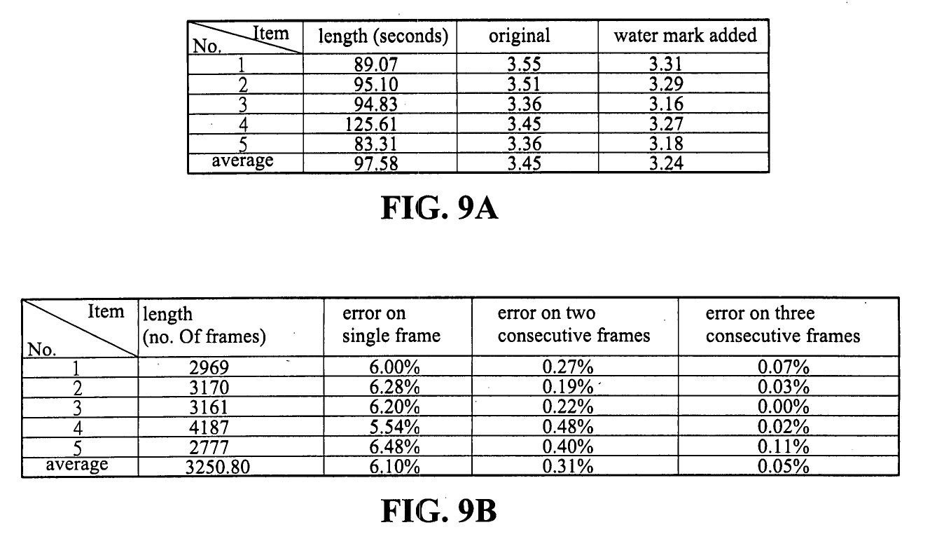

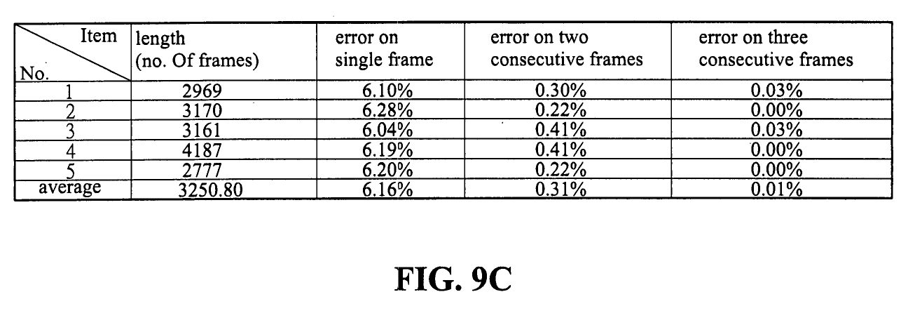

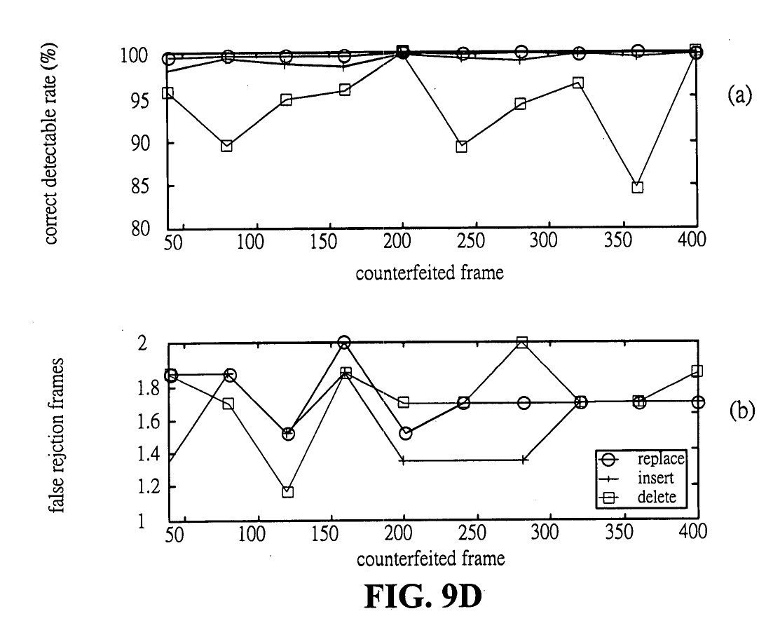

FIGS. 9A-9D show the experiments and the results of the present invention. FIG. 9A shows the experiment subjects. A plurality of dialogs of 1-3 minutes are extracted from a CD containing English teaching material. Each dialog is conducted by 2-3 persons, both male and female. The sampling rate is reduced from 44.1 KHz to 8 KHz. The dialogs are encoded with both the original encoder and the modified encoder. The modified encoder will add watermarks during the encoding process, while the original encoder does not. Both are decoded by the original decoder, and the decoded speech data are analyzed with PESQ proposed by ITU-T P.862. FIG. 9A shows the PESQ results of the speech data decoded from the G.723.1 encoded data with and without watermarks. As shown, the speech quality from the encoded data with addition of watermarks is lowered by 0.2 in the PESQ value, which illustrates that the watermark addition mechanism of the present invention does not greatly degrade the speech quality.

The second experiment is related to the effectiveness of the watermark. Most of the available digital recording devices use real-time encoding chips to encode the live speech and store it into the storage device without storing the original waveform. Therefore, any malicious tampering can only perform on the encoded data, not on the original waveform. There are two schemes to change the encoded speech data. The first scheme is to transform the data back to the original waveform, and re-encode it after the changes. The second is to directly change the encoded speech data. The experiments in FIGS. 9B-9D are used to prove that the watermark mechanism provided by the present invention will be damaged by any kind of tampering in speech data. Based on the damage types of watermarks, the tampering locations and ways can be determined.

Five segments of speech are transformed back to the original waveform and re-encoded with the original encoder. This is to check the damage in the new encoded data. FIG. 9B shows the false acceptance rate of the embodiment. The false acceptance implies that the damaged watermarks are treated as an intact watermark. As shown in FIG. 9B, there is 6.10% of the damaged frames being falsely accepted, the false acceptance rate for two consecutive frames is reduced to 0.31%, and further reduced to 0.05% for three consecutive frames. This shows that most false acceptances are isolated and sparsely distributed. The consecutive frames errors occur rarely.

FIG. 9C shows the similar experiments as in FIG. 9B, except that a 5 dB Gaussian noise is added to the transformed waveform before it is re-encoded with the original encoder for watermark checking. As shown in FIG. 9C, the false acceptance situation is similar to that of FIG. 9B. While there is a false acceptance rate of 6.16% for a single frame, the rate is reduced to 0.01% for three consecutive frames. Therefore, the false acceptance can be attributed to the content of the speech data.

According to the results in FIG. 9B and FIG. 9C, when the recorded speech data (with watermark added) is decoded, changed, and re-encoded, the watermarks are damaged and can be easily identified for tampering. Therefore, it cannot serve as evidence in the court of law.

However, the results in FIG. 9B and FIG. 9C can only prove that the malicious tampering in the waveform domain can be prevented, but not in the compressed domain. FIG. 9D, on the other hand, shows the prevention works as well in the compressed domain.

In the experiment shown in FIG. 9D, a proprietary program is developed to delete, substitute and insert part of speech data without transforming the compressed data back to waveform. As shown in FIG. 9D(a), when the speech data are substituted or inserted, the detection rate is as high as 97.54%, while the detection rate is 84.75% for deletion tampering. This shows that the present invention, under most circumstances, can detect the tampering location. On the other hand, FIG. 9D(b) shows the false rejection, which means an intact frame is falsely identified as damaged, occurs once or twice in average. The reason of false rejection is that the tampering of one frame will sometimes affect the neighboring frames.

To evaluate the quality of the reconstructed speech, five segments of speech data having lengths of 1000-3000 frames are selected to be deleted or substituted with a noise having the length of 500-1000 frames, and then reconstructed with the mechanism provided in the present invention. Ten persons are asked to evaluate the quality of the reconstructed speech, and more than 70% can identify the content and the identity of the participants of the dialog. Only 30% of the persons cannot identify the content of the dialog. Furthermore, about 46.30% of the testee expressed that the reconstructed signals having volume change and pre-mature termination of the dialog. This may be resulted from speech transition periods in which no effective interpolation can approximate.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A speech watermark system, for determining the integrity of speech data by identifying said watermarks added to said speech data and for reconstructing said speech data according to reconstruction information, said system comprising:
a watermark generation and addition device, said watermark generation and addition device being based on a watermark generation mechanism, and adding said speech watermarks and said reconstruction information to said speech data, said watermarks being constructed according to time information and contents of said speech;
a watermark extraction and identification device, said watermark extraction and identification device being based on said watermark generation mechanism and extracting said speech watermarks from said speech data to which said watermarks been added, and generating identification watermarks based on said watermark generation mechanism from said speech data, by comparing said identification watermarks and said extracted speech watermarks to determine the result of identification;
a tampering identification device, said tampering identification device being based on estimating said time information of said corresponding speech watermarks in damaged speech frames to obtain tampered locations and tampering ways used to tamper said speech data; and
a damaged area reconstruction device, said damaged area reconstruction device being based on a type and said location of tampering to determine reconstruct-able areas of said speech data and extract said corresponding reconstruction information from said speech data to reconstruct said reconstruct-able area.

2. A watermark generation and addition device, for adding watermarks to a speech data without affecting or with little degrade said speech quality, said speech data comprising a plurality of frames, said device comprising:
a time information generation unit, for generating time information based on the order of relative locations among frames, time, or content;
a speech characteristic extraction unit, for generating a speech characteristic based on a parameter model charactering said speech data;
a uni-directional transform function unit, being a machine dependent uni-directional transformation function to transform said time information and said speech characteristic into said watermark; and
a watermark addition unit, for adding said watermark to said speech data by changing the secondary parameter having the least impact on said speech quality.

3. The device as claimed in claim 2, wherein said time information is a speech length or a number of frames of said speech data.

4. The device as claimed in claim 2, wherein a specific number of frames are defined as a group and said time information is a group index corresponding to said group or said generated watermark.

5. The device as claimed in claim 4, wherein said group index is generated by transforming the frame time or a sequence number of said group with a time transformation function.

6. The device as claimed in claim 5, wherein said time transformation function is Mod(sequence number of said group, 2^{a}), and a is the number of bits of said watermarks that can be stored in a frame.

7. The device as claimed in claim 2, wherein said model parameter is a line spectral pair (LSP), a speech pitch, or an energy.

8. The device as claimed in claim 2, wherein said speech characteristic consists of a part or all of said LSP and said speech pitch of said frame.

9. The device as claimed in claim 8, wherein if said frame is not the last of said speech data, said speech characteristic comprises a specific number of bits from said LSP of said frame and a specific number of bits from said pitch of said frame.

10. The device as claimed in claim 8, wherein a specific number of frames are defined as a group, and if said frame is the last frame of said speech data, said speech characteristic comprises a specific number of bits from said LSP of said frame and a specific number of bits from said pitch defined by Mod(eof, 2^{b}), where eof is the number of frames within said final group, and b is the number of bits of speech pitch.

11. The device as claimed in claim 2, wherein said secondary parameter is a parameter, when slightly changed, will not obviously affect the encoded results of said speech data.

12. The device as claimed in claim 2, wherein when said secondary parameter is an excitation signal, said watermark addition unit adds said watermark to said speech data by changing the least significant bit (LSB) of said excitation signal.

13. The device as claimed in claim 2, further comprising:
a reconstruction information extraction unit for obtaining a reconstruction information by using re-estimating model, re-quantization or interpolation, and for storing said reconstruction information to a register.

14. The device as claimed in claim 13, herein when said secondary parameter is an excitation signal, said watermark addition unit adds said reconstruction information to said speech data by changing the least significant bit (LSB) of said excitation signal.

15. A watermark extraction and identification device, for being based on said watermark generation mechanism and extracting said speech watermarks from said speech data to which said watermarks been added, and generating an identification watermark based on said watermark generation mechanism from said speech data, by comparing said identification watermarks and said extracted speech watermarks to determine the result of identification, said device comprising:
a watermark extraction unit, for extracting said watermark from said speech data;
a time information generation unit, for generating a time information based on the order of relative locations among frames, time, or content;
a speech characteristic extraction unit, for generating a speech characteristic based on a parameter model charactering said speech data;
a uni-directional transform function unit, being a machine dependent uni-directional transformation function to transform said time information and said speech characteristic into said watermark; and
a watermark identification unit, for comparing said extracted watermark and said identification watermark to determine the correctness of said watermark in said speech data.

16. The device as claimed in claim 15, wherein said time information is a speech length or a number of frames of said speech data.

17. The device as claimed in claim 15, wherein a specific number of frames are defined as a group and said time information is a group index corresponding to said group or said generated watermark.

18. The device as claimed in claim 17, wherein said group index is generated by transforming a frame time or a sequence number of said group with a time transformation function.

19. The device as claimed in claim 18, wherein said time transformation function is Mod(sequence number of said group, 2^{a}), and a is the number of bits of said watermarks that can be stored in a frame.

20. The device as claimed in claim 15, wherein said model parameter is a line spectral pair (LSP), a speech pitch, or an energy.

21. The device as claimed in claim 15, wherein said speech characteristic consists of a part or all of said LSP and said pitch of said frame.

22. The device as claimed in claim 21, wherein if said frame is not the last of said speech data, said speech characteristic comprises a specific number of bits from said LSP of said frame and a specific number of bits from said pitch of said frame.

23. The device as claimed in claim 21, wherein a specific number of frames are defined as a group, and if said frame is the last frame of said speech data, said speech characteristic comprises a specific number of bits from said LSP of said frame and a specific number of bits from said pitch defined by Mod(eof, 2^{b}), where eof is the number of frames within said group, and b is the number of bits of speech pitch.

24. The device as claimed in claim 15, further comprising:
a reconstruction information extraction unit, said reconstruction information extraction unit taking said reconstruction information stored in said frame without re-computing.

25. A tampering identification device, for analyzing a tampering type, a tampering way and a tampering location of a tampering performed on speech data, said speech data comprising a plurality of groups, each further comprising a specific number of frames, said device comprising:
a watermark damage type database, comprising at least a tampering type definition, said definition defining a head damage, a tail damage, and a middle damage according to a time information type on which a generated watermark being based and said tampered location of said frame within said group;
a damage identification unit, for analyzing, based on said damage type definition, a damaged area to conclude a damage type of said damaged area, said damaged area at least covering a frame; and
an identification unit for obtaining a group index from each corresponding group and using an overall method corresponding to said damage type to analyze, according to a rule, the contents of said group index in order to conclude with said tampering way and tampering location of said damaged area of said speech data.

26. The device as claimed in claim 25, wherein said frame using said group index of said group as said time information is the first frame of said group.

27. The device as claimed as in claim 25, wherein said speech data having said head damage or said tail damage is tampered by either insertion or deletion, and said speech data having said middle damage is tampered by insertion, deletion or substitution.

28. The device as claimed in claim 25, wherein said rule is that if the continuity of said group index is correct and said speech data terminates normally, said damaged area is tampered by a substitution.

29. The device as claimed in claim 25, wherein said rule is that if the continuity of said group index is incorrect, said damaged area is tampered by an insertion or a deletion.

30. The device as claimed in claim 25, wherein said rule is that if the continuity of said group index is incorrect and the non-consecutive group indexes are neighboring, or the continuity of said group index is correct and said speech data terminates abnormally, the starting location of said damaged area is the starting location of said damaged area being tampered by a deletion.

31. The device as claimed in claim 25, wherein said rule is that if the continuity of said group index is incorrect and the consecutive group indexes are not neighboring, the starting location of said damaged area is the starting location of said damaged area being tampered by an insertion.

32. A damaged area reconstruction device, for reconstructing a damaged area according to a reconstruction information, said device comprising:
a reconstruct-able area identification unit, for receiving a tampering type and tampering location of speech data and determining which damaged areas of said speech data being reconstruct-able;
a location transformation unit, for finding a watermark of a reconstruction information required by said reconstruct-able area, said watermark being added in said frame;
a reconstruction information extraction unit, for extracting said reconstruction information from said reconstruct-able area of said frame; and
a damaged speech construction unit, for reconstructing said reconstruct-able area according to said reconstruction information extracted by said reconstruction information extraction unit.

33. The device as claimed in claim 32, wherein if said reconstruction information for said damaged area can be found in a register according to said tampering type and tampering location, said damaged area is determined to be a reconstruct-able area.
